(19) United States
(12) Patent Application Publication
(10) Pub. No.: US 2023/0362290 A1
(43) Pub. Date: Nov. 9, 2023

(54) MAGNETIC CASE FOR AN ELECTRONIC DEVICE

(71) Applicant: YINSUO GUAN, Shenzhen (CN)

(72) Inventor: YINSUO GUAN, Shenzhen (CN)

(21) Appl. No.: 18/221,886

(22) Filed: Jul. 14, 2023

(51) Int. Cl. H04M 1/60; A45C 11/00; B32B 17/10; B32B 27/08; B32B 27/36; B32B 7/12; B32B 27/40; H04M 1/04

(52) U.S. Cl. CPC H04M 1/6041; A45C 11/00; B32B 17/10; B32B 27/08; B32B 27/365; B32B 7/12; B32B 27/40; H04M 1/04; B32B 2457/00; A45C 2011/002; B32B 2274/00; B32B 2307/56

(57) ABSTRACT

Provided is a case for an electronic device having a front face, a rear face, a top edge, a bottom edge, and two opposing side edges. The case includes a body for covering at least a portion of the rear face of the electronic device. The body includes a composite sheet. Further, the case includes a magnetic unit embedded in the body. Furthermore, the case includes a thermoplastic polyurethane (TPU) bumper. The body is integrated with the TPU bumper to form the case.

### TECHNICAL FIELD

The present invention relates generally to protective cases for mobile or handheld electronic devices, and more particularly, to protective cases that embodies embedded magnetic component.

### BACKGROUND

Mobile electronic devices, such as smartphones and tablets, have become an integral part of everyday life for many consumers. Modern mobile phones are growing in complexity, offering users an array of advanced features and functionalities, including telephony, internet access, multimedia capabilities, navigation, and more. Among these features, the integration of a compact camera has become a common and popular addition. This camera allows users to capture images and videos, serving various purposes such as personal enjoyment, documentation, or even engaging in real-time video conferences with other mobile phone or computer users. As a result, users often carry their mobile devices with them wherever they go. Users often rely on protective cases to safeguard their devices from damage and enhance their overall user experience. However, conventional mobile cases lack certain features and flexibility that can limit their effectiveness and customization options.

One limitation of existing mobile cases is the fixed design of the camera ring and buttons. Users may desire different camera rings or buttons to suit their aesthetic preferences or functional requirements. Moreover, the materials used in these fixed components may not always meet users' expectations in terms of durability and style. Additionally, traditional mobile cases often lack an efficient and secure mounting mechanism. Users may desire to attach their devices to various objects or surfaces for hands-free use or convenient viewing. For example, mounting a smartphone on a car dashboard for hands-free navigation or attaching a tablet to a stand for comfortable viewing. However, existing cases do not provide a reliable and versatile solution for such mounting needs. Further, existing mobile device holders and mounting systems have limitations that hinder users' experience.

Various attempts have been made to improve the mounting features of the protective cases. However, conventional mobile device protective cases may not provide consumers with ready and secure access to their mobile devices. For example, the use of mechanical attachment stands for mobile cases exhibiting certain challenges and limitations. One common issue is the lack of versatility and adjustability in positioning the mobile device. Mechanical stands often have fixed angles or a limited range of motion, restricting users from finding the optimal viewing or typing angle. Additionally, the mechanical attachment mechanism may not provide a secure and stable hold, leading to potential slippage or instability of the mobile device when mounted. These drawbacks can result in inconvenience and frustration for users, hindering their overall experience and utility of the mobile case.

Although mobile device protective cases are proposed in the past, they have their own shortcomings or limitations, thus there still exists a need for a more reliable mobile device protective case that improvise user experience and addresses the limitations of existing mobile cases in terms of customization, durability, and mounting options.

### SUMMARY

It will be understood that this disclosure is not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only and is not intended to limit the scope of the present disclosure.

In an embodiment, the present invention provides a case for an electronic device having a front face, a rear face, a top edge, a bottom edge, and two opposing side edges. The case includes a body covering at least a portion of the rear face of the electronic device, the body comprising a composite sheet. Further, the case includes a magnetic unit embedded in the body. Furthermore, the case includes a thermoplastic polyurethane (TPU) bumper, wherein the body is integrated with the TPU bumper to form the case.

In an embodiment, the body includes at least one first cut-out portion for revealing at least one camera of the electronic device. Further, at least one of the first cut-out portion is accommodated with a groove made around a camera ring.

In an embodiment, each of the side edges of the case includes at least one second cut-out portion for removably receiving at least one button.

In an embodiment, the body is made from at least one of metal, glass, concrete, epoxy, plastics, nylon, polylactic acid, high impact polystyrene, polycarbonate, acrylonitrile butadiene styrene, grapheme, Kevlar, fiberglass, and carbon fiber.

In an embodiment, the composite sheet includes a back glass or Polyethylene terephthalate (PET) acting as the rear face of the case, a layer of first compound UV glue applied on top of the back glass or PET, an intermediate polycarbonate (PC) sheet placed on the first compound UV glue, wherein the top side of the PC sheet is used for placement of the magnetic unit through a CNC processing slot, and the bottom side of the PC sheet is placed on the first compound UV glue, a layer of second compound UV glue applied on top of the intermediate PC sheet, and a front glass or Polyethylene terephthalate (PET) configured on top of the intermediate PC sheet through the second compound UV glue and acts as the front face of the case.

In an embodiment, the magnetic unit further includes a PC ring with an intermediate processing slot for receiving one or more magnets, a first layer of glue for sticking the one or more magnets on top of the PC ring, the one or more magnets placed on top of the first glue layer, and a second layer of glue applied on top of the one or more magnets configured on the PC ring for attaching a PET cover for covering the one or more magnets.

In an embodiment, the back glass or Polyethylene terephthalate (PET), and the front glass or Polyethylene terephthalate (PET) comprises a printed layer shaped like a magnetic unit.

In an embodiment, the magnetic unit allows for secure attachment of compatible accessories.

In an embodiment, the composite sheet is securely attached to the TPU bumper through an adhesive bonding process.

In an embodiment, a magnetic unit embedded within the composite sheet facilitates magnetic attachment to compatible accessories, such as magnetic car mounts or stands.

In an embodiment, the composite sheet is formed through a molding process, ensuring precise fit and alignment of the components of the composite sheet.

In an embodiment, the electronic device is a cellular telephone or a smartphone.

In an embodiment, the composite sheet is formed using injection molding or other suitable manufacturing processes.

In an embodiment, the TPU bumper is constructed with a shock-absorbing material to provide enhanced impact resistance.

In another embodiment, the present invention provides the case for the electronic device having the front face, the rear face, the top edge, the bottom edge, and two opposing side edges. The case includes the body for covering at least a portion of the rear face of the electronic device. wherein the body includes the composite sheet, and the thermoplastic polyurethane (TPU) bumper, wherein the body is integrated with the TPU bumper to form the case. Further, the composite sheet includes the back glass or Polyethylene terephthalate (PET) acting as the rear face of the case, the layer of first compound UV glue applied on top of the back glass or PET, the intermediate polycarbonate (PC) sheet placed on the first compound UV glue, wherein the top side of the PC sheet is used for placement of the magnetic unit and the bottom side of the PC sheet is placed on the first compound UV glue, the layer of second compound UV glue applied on top of the intermediate PC sheet, and the front glass or Polyethylene terephthalate (PET) configured on top of the intermediate PC sheet through the second compound UV glue and acts as the from face of the case.

These and other features and advantages of the present invention will become apparent from the detailed description below, in light of the accompanying drawings.

### BRIEF DESCRIPTION OF THE DRAWINGS

FIG. 1 illustrates a case for an electronic device, according to an exemplary embodiment of the present invention;

FIG. 2 illustrates an exploded view of the case for the electronic device, according to an exemplary embodiment of the present invention;

FIG. 3 illustrates an exploded view of a composite sheet of the case, according to an embodiment of the present invention;

FIG. 4 illustrates an exploded view of a magnetic unit of the case, according to an embodiment of the present invention; and

FIG. 5 illustrates an exploded view of the case including the composite sheet and the magnetic unit, according to an embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event, such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a case for an electronic device. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items. Further, the word “user” and “person” are used interchangeably in the description.

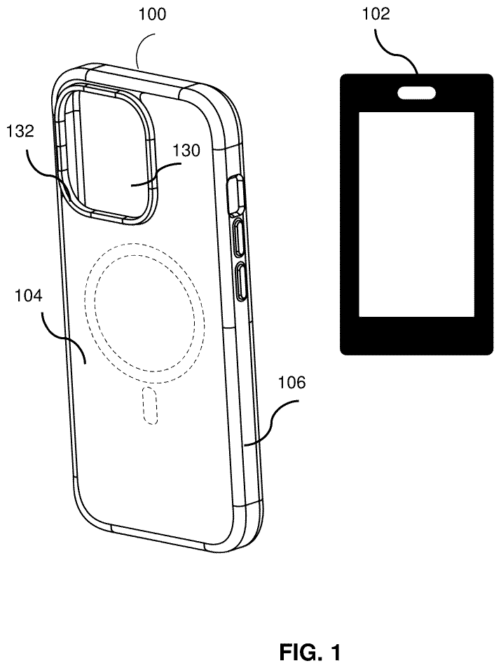

A case for an electronic device will now be described with reference to the accompanying drawings, particularly FIGS. 1-5.

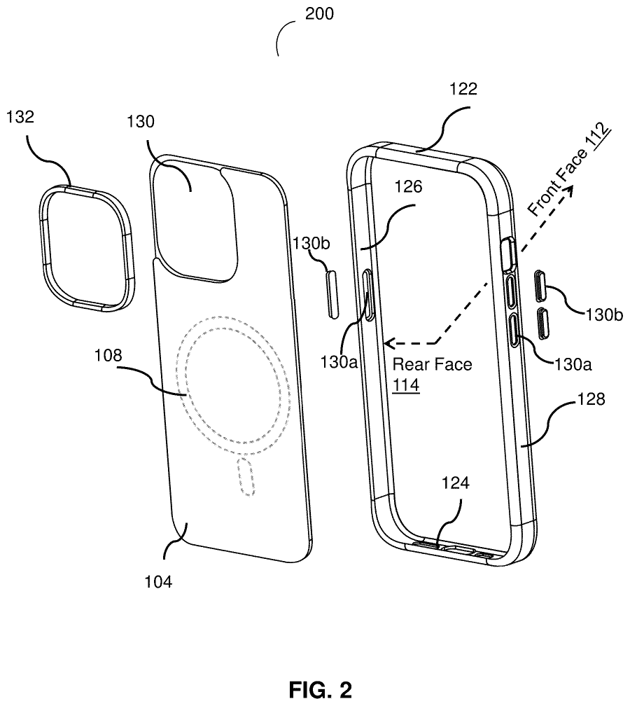

Referring to FIG. 1 in conjunction with FIGS. 2-5, a case 100 for an electronic device 102 is shown, in accordance with an exemplary embodiment of the present invention. As can be seen in FIG. 1, the cell phone case 100 includes a back surface 104 and side surfaces 106 that are designed to hold the electronic device 102, for example, a cell phone. The primary function of the case 100 is to encase and shield the rear face of the electronic device 102 from potential damage, such as scratches, impacts, or dust. Further, the case covers at least a portion of the rear face of the electronic device 102, which means it may partially or completely wrap around the back surface of the electronic device 102.

In an embodiment, the back surface 104 of the case 100 includes at least one first cut-out portion 130 for revealing at least one camera of the electronic device 102. Further, the first cut-out portion 130 is accommodated within a groove (not seen) made around a camera ring 132. Further, the removable camera ring 132 can be aligned properly around the cut--out circumference to ensure precise positioning and alignment of the camera ring 132 around the cut-out portion 130. Further, the camera ring 132 is detachable from the cut-out portion 130 by releasing the cut-out portion 130 from the groove and can be replaced with an alternative camera ring of a different design or material, Furthermore, the camera ring 132 is made of aluminum, stainless steel, or titanium for enhanced durability and aesthetics.

Further, each of the side surfaces/edges of the case 100 includes at least one second cut-out portion 130a for removably receiving at least one button 130b. Thus, the camera ring 132 and buttons 130b are easily removable and replaceable. In an embodiment, the removable buttons are made of a flexible material that allows for easy installation and removal without compromising the structural integrity of the mobile case. In an embodiment, the removable buttons 130b are made from materials such as Polycarbonates (PC), Acrylonitrile Butadiene Styrene (ABS) plastic, or aluminum, allowing for easy detachment and replacement. In an embodiment, the buttons 134b can be customizable according to the requirement.

In an example, the back side of the case 100 includes a printed pattern (printed in the shape of magnetic ring that would be described at a later stage of the description) that enhances the aesthetic appeal of the case 100. An exploded view of the case 100 is illustrated in conjunction with FIG. 2.

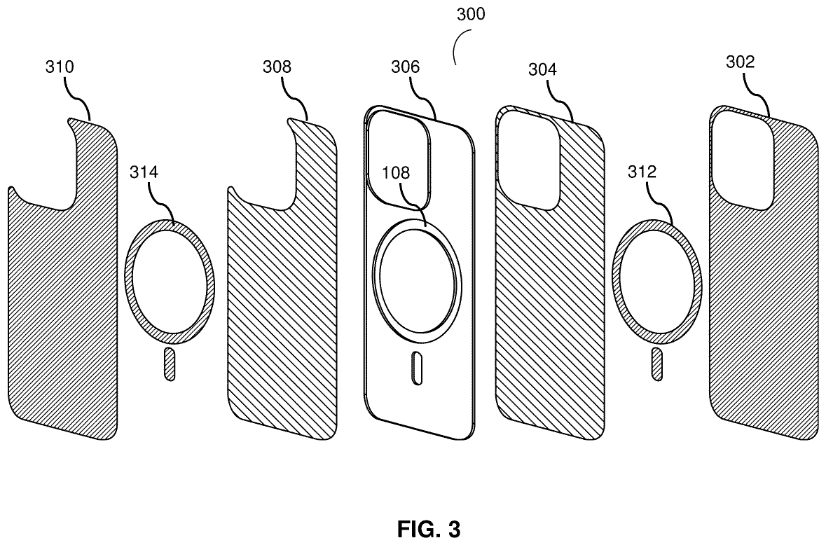

FIG. 2 illustrates an exploded view of the case 100 for the electronic device 102, according to an exemplary embodiment of the present invention. As shown, the back surface 104 includes a front face 112, and a rear face 114 that are configured to receive and retain the electronic device 102 in a position fixed relative to the back surface 104. Further, side surfaces 106 include a top edge 122, a bottom edge 124, and two side edges 126 and 128. In an embodiment, the body of the case 100 that includes the back surface 104 covers at least a portion of the rear face of the electronic device 102. Further, the body comprises a composite sheet. In the context of the present embodiment, a composite sheet is a sheet made by combining multiple layers or materials together to create a single, unified sheet. In an embodiment, the body is made from at least metal, glass, concrete, epoxy, plastics, nylon, polylactic acid, high impact polystyrene, polycarbonate, acrylonitrile, butadiene styrene, grapheme, Kevlar, fiberglass, and carbon fiber. Further, the materials of the composite sheet are chosen based on the desired properties and characteristics. In an embodiment, the composite sheet is transparent, allowing the original design and color of the mobile device 102 to be visible through case 100. An exploded view of the composite sheet is illustrated in conjunction with FIG. 3.

Further, the composite sheet is chosen for its specific attributes, which can include durability, flexibility, rigidity, impact resistance, heat resistance, water resistance, or any other desired properties based on the intended use of the case. Furthermore, the composite sheet is carefully manufactured and shaped to fit the contours of the rear face of the electronic device 102. It may be molded, cut, or formed to achieve the desired shape and dimensions for a precise fit.

In an embodiment, a magnetic unit 108 is embedded within the body of the case 100, which means it is securely placed or incorporated into the structure of the case 100 itself. This integration ensures that the magnetic unit 108 remains in place and functions effectively. Magnetic unit 108 is constructed using materials that exhibit magnetic properties, such as ferromagnetic or neodymium magnets. These magnets possess the ability to attract or repel other magnetic objects or materials. In one embodiment, the magnetic unit 108 is exemplified as neodymium iron boron magnets. However, it should be understood that this is provided as an illustration, and various other types of magnets, or combinations thereof, can be used, which exhibit similar properties to neodymium iron boron magnets. It is also important to note that while the illustrations depict the magnetic unit 108 with a circular shape, magnets can adopt practically any shape, including square, hexagonal, and others, according to user preferences. Additionally, the magnets can be coated with different materials such as nickel, silver, or gold plating, or they can be painted with a variety of colors and patterns.

The magnetic unit 108 serves a specific purpose within the case. Without further context, the exact function of the magnetic unit 108 can vary depending on the specific design and intended use of the case 100. For example, the magnetic unit 108 may be utilized to facilitate magnetic attachment or alignment with other accessories or components, such as mounting systems, holders, or charging docks. The magnetic unit 108 can provide a convenient and secure method for attaching or detaching the case 100 from various magnetic surfaces or interfaces.

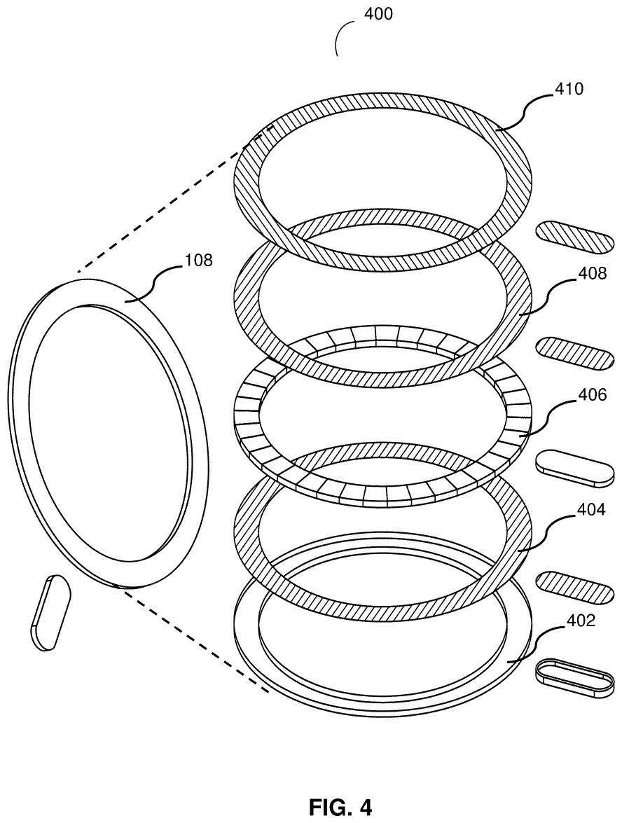

Further, the magnetic unit 108 is designed to possess a certain level of magnetic strength suitable for its intended purpose. The strength can be determined based on factors like the size, type, and configuration of the magnets used within the unit. The magnetic unit 108 is strategically positioned or located within the body of the case 100 to optimize its functionality. The exact placement can vary depending on the specific requirements of the case and the desired magnetic interaction with other objects or components. An exploded view of the magnetic unit 108 is illustrated in conjunction with FIG. 4.

Furthermore, the case 100 features a specially designed bumper made of thermoplastic polyurethane (TPU) material. In the context of the present embodiment, side surfaces 106 can be considered a TPU bumper. The TPU bumper serves as an integral part of the case 100 and plays a crucial role in providing additional protection and impact resistance to the electronic device 102 it encloses. Thermoplastic polyurethane (TPU) is a versatile and durable material widely used in various industries, including electronics and consumer products. TPU possesses a unique combination of properties that make it well-suited for protective applications. TPU is known for excellent flexibility, elasticity, and high tensile strength, which allows it to withstand external forces and deformations without permanent damage.

The TPU bumper is specifically engineered to fit seamlessly within the overall design of the case. The TPU bumper is strategically positioned along the edges and corners of the case to provide enhanced protection against impacts and accidental drops. The TPU bumper acts as a shock absorber, cushioning the electronic device from sudden jolts or vibrations that could potentially cause damage. One of the primary functions of the TPU bumper is to dissipate and distribute the forces generated upon impact. When the electronic device 102 experiences a fall or collision, the TPU bumper absorbs the energy and disperses it throughout the bumper's structure, minimizing the impact on the device itself. Thus, helping in reducing the risk of cracks, scratches, or other damage to the electronic device, preserving its integrity. Moreover, the TPU material offers excellent resistance to abrasion, tear, and wear. This ensures that the bumper maintains its protective properties even after prolonged use, providing long-lasting defence for the electronic device 102 against daily hazards and accidents.

Additionally, the TPU bumper is designed to have a precise fit, allowing for easy installation and removal of the case. It securely wraps around the edges and corners of the electronic device 102, providing a snug and secure fit. This ensures that the case 102 stays in place during regular use, minimizing the chance of accidental slips or dislodgment. The TPU bumper is an integral component of the overall case design, working in conjunction with other elements to provide comprehensive protection. It complements the body of the case 100, which covers the rear face of the electronic device 102, by adding an extra layer of defence against impacts and shocks. The TPU bumper is described in conjunction with FIG. 2.

It should be noted that while the various embodiments of the case 100 are described by way of example and with reference to a cell phone case, the same principles can be used for a variety of cases having various dimensions and shapes that are configured to hold a device, such as, for example, a personal digital assistant (PDA), a digital music player, a tablet computer or a digital camera, just to mention a few examples.

FIG. 3 illustrates an exploded view of the composite sheet 300 of the case 100, according to an embodiment of the present invention. In an embodiment, the composite sheet 300 includes a back glass 302 or Polyethylene terephthalate (PET) 302 that acts as the rear face of the case 100. Thus, providing a solid foundation and protection for the electronic device 102. The selection of the hack glass 302 or Polyethylene Terephthalate (PET) material for the rear face of the case 100 is based on several desirable properties that contribute to the overall functionality and protection of the electronic device 102. In an example, the back glass 302 or PET material possesses inherent strength and rigidity, allowing it to withstand various external forces and impacts. This ensures that the electronic device 102 is well-protected from accidental drops, bumps, or other physical hazards that it may encounter during regular usage.

Further, transparency is a crucial characteristic of the back glass 302 or PET material. It allows the electronic device's design and features to remain visible and accessible while encased. The clear visibility ensures that the electronic device's display, buttons, ports, and other essential elements can be easily viewed and utilized by the user without hindrance. Furthermore, the back glass 302 or PET material is specifically chosen for its ability to resist scratches. This protective feature helps to maintain the aesthetic appeal of the electronic device 102 over time. By preventing surface scratches, the back glass 302 or PET material preserves the electronic case's overall appearance and keeps the device looking sleek and well-maintained. Additionally, the primary purpose of the back glass 302 or PET layer is to provide a robust barrier between the electronic device 102 and potential external impacts. It acts as a shield, absorbing and dispersing the force generated by accidental drops or collisions. By absorbing such impacts, the back glass 302 or PET layer helps prevent damage to the device's internal components, ensuring its optimal functioning and longevity.

Further, the composite sheet 300 includes a layer of first compound Ultraviolet. (UV) glue 304 applied on top of the back glass 302 or on the PET. The first compound UV glue 304 is formulated with adhesive properties that allow it to effectively bond and connect the various layers of the case. It possesses excellent bonding capabilities, ensuring a strong and durable attachment between the back glass 302 or PET and the subsequent layers. By creating a secure bond, the first compound UV glue 304 enhances the structural integrity of the case 100. It forms a reliable connection that keeps the layers firmly in place, preventing any potential separation or detachment during regular usage. This ensures that the case 100 maintains its overall strength and stability, providing optimal protection to the electronic device 102. The term “UV glue” refers to the curing process of the adhesive. When exposed to ultraviolet light, the first compound UV glue rapidly hardens and solidifies. This curing process occurs quickly, allowing for efficient production and assembly of the case. Once cured, the UV glue 304 forms a strong bond that effectively withstands the stresses and demands of everyday use. Additionally, the UV glue 304 is safe for use in electronic devices and does not pose any risk to their functionality or performance. Examples of UV glue 304 include, but not limited to a UV curable epoxy, UV-curable acrylic, UV-curable silicone, and UV-curable cyanoacrylate.

Furthermore, the composite sheet. 300 includes all intermediate polycarbonate (PC) sheet 306 placed on the first compound UV glue 304, wherein the top side of the PC sheet 306 is used for placement of the magnetic unit 108 through a CNC processing slot, and the bottom side of the PC sheet 306 is placed on the first compound UV glue 304. One notable feature of the intermediate PC sheet 306 is the CNC processing slot located on its top side. This slot is created through precision machining techniques and is designed to accommodate the placement of the magnetic unit 108. The CNC processing slot ensures a precise and secure fit for the magnetic unit 108, preventing any unwanted movement or displacement. The bottom side of the PC sheet 306 rests directly on the first compound UV glue layer 304. This arrangement ensures that the layers above the PC sheet 306 are properly supported and stabilized. The PC sheet 306 acts as a sturdy foundation, contributing to the overall strength and durability of the composite sheet 300. In an example, polycarbonate is chosen as the material for the intermediate PC sheet 306 due to its desirable properties. Polycarbonate is known for its excellent impact resistance, high tensile strength, and optical clarity. It is also lightweight, making it a suitable choice for applications where weight reduction is desired.

Furthermore, the composite sheet 300 includes a layer of second compound UV glue 308 applied on top of the intermediate PC sheet 306. The primary function of the second compound UV glue 308 is to securely attach a front glass 310 or PET to the intermediate PC sheet 306, creating a strong and reliable bond between the layers. One of the key characteristics of the second compound UV glue 308 is its adhesive strength. It is formulated to provide a firm and durable attachment between the front glass 310 or PET and the intermediate PC sheet 306. This ensures that the layers remain securely bonded, even under various environmental conditions and stresses. The properties of the second compound UV glue 308 may be similar to the first compound UV glue 304.

Furthermore, the composite sheet 300 includes the front glass 310 or Polyethylene terephthalate (PET) configured on top of the intermediate PC sheet 306 through the second compound UV glue 308 and acts as the front face of the case 100. One of the primary purposes of the front glass 310 or PET is to offer an additional layer of protection for the electronic device's back. It acts as a barrier, safeguarding the electronic device 102 from external impacts, scratches, and dust particles. The front glass or PET is chosen for its durability and scratch resistance properties, ensuring that the display remains free from damage and maintains its pristine condition. Moreover, the front glass 310 or PET is carefully selected for its optical clarity. It is designed to have excellent transparency, allowing for clear visibility of the device's back. The properties of the back glass 302 and the front glass 310 may be similar.

The combination of these layers in the composite sheet 300 results in a robust, visually appealing, and functional case for the electronic device 102. The specific materials and layers used can vary based on design preferences and requirements, providing flexibility for customization. The composite sheet 300 construction ensures optimal protection, structural integrity, and a seamless user experience for the electronic device.

In an embodiment, the back glass 302 or Polyethylene terephthalate (PET), and the front glass 310 or Polyethylene terephthalate (PET) includes printed layers 312 and 314 respectively. The printed layers 312 and 314 are shaped like the magnetic unit 108. In an embodiment, the back glass 302 or Polyethylene terephthalate (PET), the front glass 310 or Polyethylene terephthalate (PET), and the intermediate polycarbonate (PC) sheet 306 includes patterns that provide 3D effect to the respective layers. In another embodiment, the back glass 302 or Polyethylene terephthalate (PET), the front glass 310 or Polyethylene terephthalate (PET), and the intermediate polycarbonate (PC) sheet 306 may be electroplated to provide 3D effect to the respective layers. In yet another embodiment, the back glass 302 or Polyethylene terephthalate (PET), the front glass 310 or Polyethylene terephthalate (PET), and the intermediate polycarbonate (PC) sheet 306 may have glass finish look to provide 3D effect to the respective layers.

FIG. 4 illustrates an exploded view of the magnetic unit 108 of the case 100, according to an embodiment of the present invention. In an embodiment, the magnetic unit 108 includes a polycarbonate (PC) ring 402 with an intermediate processing slot for receiving one or more magnets 406. Further, a first layer of glue 404 is used for sticking the one or more magnets 406 on top of the PC ring 402. After applying the first layer of glue 404, the one or more magnets 406 are placed on top of the first glue layer 404. Furthermore, a second layer of glue 408 is applied on top of the one or more magnets 406 configured on the PC ring 402 for attaching a PET cover 410 for covering the one or more magnets 406.

The polycarbonate (PC) ring 402 acts as the central structure for the magnetic unit 108. The PC ring 402 is made from polycarbonate, a type of thermoplastic material known or its excellent strength, durability, and impact resistance. Polycarbonate is chosen for its mechanical properties, as it can withstand various stresses and forces without deforming or breaking. This ensures the structural integrity and longevity of the PC ring 402, The PC ring 402 is specifically designed with an intermediate processing slot that is carefully machined to accommodate the placement of one or more magnets 406. The processing slot provides a precise and secure location for the magnets, ensuring optimal alignment and stability within the magnetic unit.

The dimensions and shape of the PC ring 402 are carefully determined to match the size and configuration of the one or more magnets 406. This ensures a proper fit and alignment, allowing for efficient magnetic performance. The PC ring 402 acts as a housing or framework for the magnets, preventing their displacement or movement during usage. In addition to its functional role, the PC ring 402 may also have aesthetic considerations. It can be designed to have a visually appealing appearance, with options for different colors or finishes. This allows for customization and coordination with the overall design of the case.

Further, the first layer of glue 404 serves as an adhesive that is specifically applied to secure the one or more magnets 406 onto the top surface of the PC ring 402. Its primary function is to create a strong and reliable bond between the one or more magnets 406 and the PC ring 402, ensuring their stable attachment. The adhesive used in the first layer of glue 404 is carefully selected to provide optimal adhesion properties for the specific materials involved. It is chosen to have excellent bonding capabilities with both the surface of the one or more magnets 406 and the PC ring 402. This adhesive is typically formulated to offer strong cohesion and adhesion, allowing it to effectively join the two surfaces together. During the assembly process, the first layer of glue 404 is carefully applied to the top surface of the PC ring 402. The one or more magnets 406, which are also prepared for bonding, are then positioned onto the first glue layer 404, ensuring proper alignment and contact with the adhesive. Pressure may be applied to facilitate the adhesion process and ensure maximum contact between the one or more magnets 406 and the first glue layer 404.

Once the one or more magnets 406 are in place, the first layer of glue 404 undergoes a curing or drying process, depending on the specific adhesive used. This allows the adhesive to form a strong bond between the one or more magnets 406 and the PC ring 402, creating a secure attachment. The adhesive properties of the first layer of glue 404 are crucial for the overall functionality and durability of the magnetic unit. It ensures that the magnets 406 remain firmly affixed to the PC ring 402, even when subjected to external forces or vibrations. This secure attachment enables the one or more magnets 406 to effectively perform their magnetic function within the case 100, providing the desired functionality and stability.

Furthermore, the one or more magnets 406 are placed in a specific arrangement or pattern that is predetermined based on the design and functionality requirements of the magnetic unit 108. The magnets 406 are positioned in direct contact with the first glue layer 404, ensuring proper adhesive bonding between the one or more magnets 406 and the PC ring 402. The one or more magnets 406 may be aligned in a particular orientation or configuration to achieve the desired magnetic field strength or polarity. During the placement process, it is important to ensure that the one or more magnets 406 are accurately positioned and firmly pressed onto the first glue layer 404. This allows for maximum contact and optimal adhesion between the magnets and the adhesive. Pressure may be applied to ensure a secure and uniform attachment.

The magnets 406 may have specific dimensions, shapes, and magnetic properties that are chosen to meet the desired functionality of the magnetic unit. These magnets are typically made from materials with strong magnetic properties, such as neodymium iron boron (NdFeB) or other suitable magnetic materials. Once the one or more magnets 406 are positioned on the first glue layer 404, the adhesive undergoes a curing or drying process, depending on the specific characteristics of the adhesive used. This allows the adhesive to bond the magnets securely to the PC ring 402, creating a stable and durable connection. By placing the one or more magnets 406 on top of the first glue layer 404, the adhesive ensures their fixed position and prevents any movement or displacement during the usage of the case 100. This secure attachment allows the magnets to effectively perform their magnetic function, providing the desired magnetic features and functionality to the case.

Furthermore, after the one or more magnets 406 are positioned on top of the first glue layer 404 and securely attached to the PC ring 402, a second layer of glue 408 is applied on top of the magnets. The purpose of this second glue layer 408 is to facilitate the attachment of the PET cover 410, which is intended to cover and protect the one or more magnets 406. The second layer of glue 408 is carefully applied to ensure complete coverage of the magnets 406, forming a uniform layer on their exposed surfaces. This adhesive layer serves as a bonding agent that enables the PET cover 410 to adhere firmly to the one or more magnets 406, ensuring a secure and stable connection.

The adhesive used in the second layer of glue 408 is chosen to have excellent adhesion properties with both the surface of the magnets 406 and the material of the PET cover 410. It is formulated to provide strong cohesion and adhesion, creating a reliable bond between these components. Once the second glue layer 408 is applied, the PET cover 410 is positioned on top of the one or more magnets 406, ensuring proper alignment and contact with the adhesive layer. Pressure may be applied to ensure optimal adhesion and uniform attachment. The PET cover 410 acts as a protective layer, covering and shielding the one or more magnets 406 from external elements, such as dust, moisture, or physical impacts. It contributes to the overall durability and longevity of the magnets by providing an additional barrier of protection. The adhesive in the second layer of glue 408 undergoes a curing or drying process, allowing it to fully bond the PET cover 410 to the one or more magnets 406. This ensures a secure and durable attachment, preventing any movement or detachment of the cover during normal usage of the case.

It should be noted that the specific adhesive used in the second layer of glue 408 may vary depending on factors such as the materials of the magnets and the PET cover 410, environmental considerations, and desired bonding strength. Various types of adhesives, such as epoxy, cyanoacrylate, or other suitable adhesive formulations, can be employed to achieve the desired bonding characteristics. The attachment of the PET cover 410 to the one or more magnets 406 with the second layer of glue 408 completes the assembly of the magnetic unit 108. The cover not only provides protection for the magnets but also contributes to the overall aesthetic appeal of the case, giving it a polished and finished appearance.

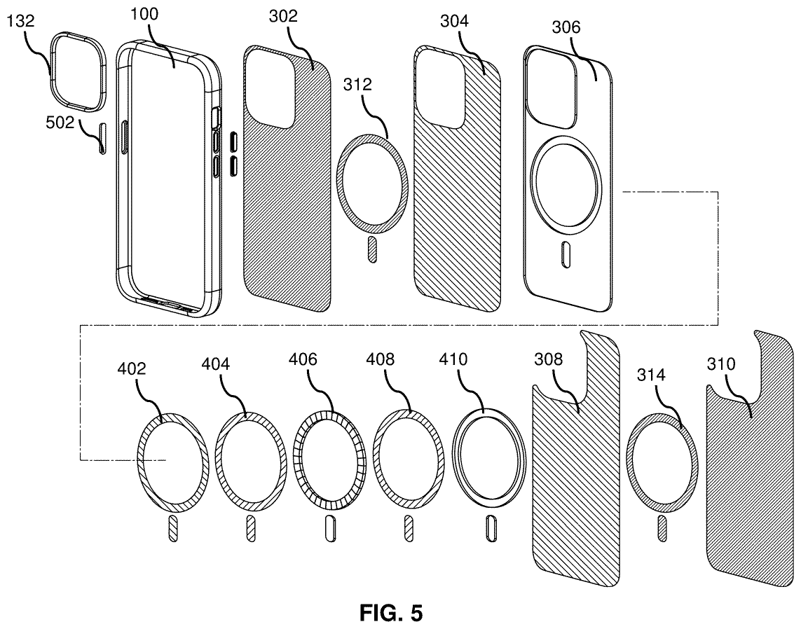

FIG. 5 illustrates an exploded view of the case 100 including the composite sheet 300 and the magnetic unit 108, according to an embodiment of the present invention. As shown the case 100 for an electronic device 102 having the front face 112, the rear face 114, the top edge 122, the bottom edge 124, and two opposing side edges 126 and 128. The case 100 includes the body that covers at least a portion of the rear face of the electronic device 102, and the body is composed of the composite sheet 300. Further, the case 100 includes the magnetic unit 108 embedded in the body. Further, the case 100 includes the thermoplastic polyurethane (TPU) bumper 106, wherein the body is integrated with the TPU bumper 106 to form the case 100. in an embodiment, the body includes at least one first cut-out portion 130 for revealing at least one camera of the electronic device 102.

In an embodiment, the body is made from at least one of metal, glass, concrete, epoxy, plastics, nylon, polylactic acid, high impact polystyrene, polycarbonate, acrylonitrile butadiene styrene, grapheme, Kevlar, fiberglass, and carbon fiber.

In an embodiment, the composite sheet 300 includes the back glass 302 or Polyethylene terephthalate (PET) acting as the rear face of the case 100, the layer of first compound UV glue 304 applied on top of the back glass or PET, the intermediate polycarbonate (PC) sheet 306 placed on the first compound UV glue 304, wherein the top side of the PC sheet 306 is used for placement of the magnetic unit 108 through the CNC processing slot, and the bottom side of the PC sheet 306 is placed on the first compound UV glue 304, the layer of second compound UV glue 308 applied on top of the intermediate PC sheet 306, and the front glass 310 or Polyethylene terephthalate (PET) is configured on top of the intermediate PC sheet 306 through the second compound UV glue 308 and acts as the front face of the case 112.

In an embodiment, the magnetic unit 108 further includes the PC ring 402 with the intermediate processing slot for receiving one or more magnets 406, the first layer of glue 404 for sticking the one or more magnets 406 on top of the PC ring 402, the one or more magnets 406 placed on top of the first glue layer 404, and the second layer of glue 408 is applied on top of the one or more magnets 406 configured on the PC ring 402 for attaching the PET cover 410 for covering the one or more magnets 406.

In an embodiment, the back glass 302 or Polyethylene terephthalate (PET), and the front glass 310 or Polyethylene terephthalate (PET) includes printed layers 312 and 314 respectively. The printed layers 312 and 314 are shaped like the magnetic unit 108. Further, the magnetic unit 108 allows for secure attachment of compatible accessories. Furthermore, the composite sheet 300 is securely attached to the TPU bumper through an adhesive bonding process.

In an embodiment, the magnetic unit 108 is embedded within the composite sheet 300 facilitates magnetic attachment to compatible accessories, such as magnetic car mounts or stands. In an embodiment, the composite sheet 300 is formed through the molding process, ensuring precise fit and alignment of the components of the composite sheet. In an embodiment, the electronic device 102 is a cellular telephone or a smartphone.

In an embodiment. the composite sheet 300 is formed using the injection moulding or other suitable manufacturing processes. In an embodiment, the TPU bumper is constructed with a shock-absorbing material to provide enhanced impact resistance. Properties of different layer of the composite sheet 300 and the magnetic unit 108 is discussed in conjunction with FIG. 3 and FIG. 4.

The proposed case for the electronic device provides many advantages over the existing cases. The removable and replaceable camera ring allows users to customize their mobile case according to their preferences. They can easily switch between different camera ring designs or materials, such as metal, to suit their style or match specific occasions. Further, use of a compound sheet, which includes materials like glass and UV glue, provides a robust and long-lasting construction for the case. This ensures enhanced protection for the electronic device against impacts, scratches, and other potential damage. Further, the inclusion of a magnetic unit within the case offers a secure and reliable attachment mechanism. The magnets, along with the designated slots or areas in the TPU bumper, ensure a strong connection between the case and the electronic device. This helps prevent accidental detachment or slipping during activities or movements.

Further, the design of the case allows for convenient installation and removal. Users can easily insert or remove their device from the case without the need for complex mechanisms or tools, providing a hassle-free experience. The printed pattern on the outer side of the compound sheet adds a personalized touch to the case. Users can choose from a variety of patterns, colors, or designs to create a unique and stylish appearance that matches their individual preferences. While the case is primarily described in relation to cell phones, the principles and features of the invention can be applied to other electronic devices like personal digital assistants (PDAs), digital music players, tablet computers, or digital cameras. This versatility allows users to enjoy the benefits of the invention across a range of devices.

Further, the use of premium materials, such as metal for the camera ring and a compound sheet for the body, along with the ability to customize the case's appearance, enhances the overall aesthetic appeal of the device. It provides users with a visually appealing accessory that complements their electronic device. Further, the modular design of the case, with removable buttons and a removable camera ring, offers flexibility and adaptability to users. They can easily modify the case to suit their specific needs, such as changing button styles or using different camera rings for various photographic effects.

Although particular embodiments of the invention have been described in detail for purposes of illustration, various modifications and enhancements may be made without departing from the spirit and scope of the invention.

What is claimed is:

1. A case for an electronic device having a front face, a rear face, a top edge, a bottom edge, and two opposing side edges, the case comprising:
a body for covering at least a portion of the rear face of the electronic device, the body comprising a composite sheet;
a magnetic unit embedded in the body; and
a thermoplastic polyurethane (TPU) bumper, wherein the body is integrated with the TPU bumper to form the case.

2. The case of claim 1, wherein the body comprises at least one first cut-out portion for revealing at least one camera of the electronic device.

3. The case of claim 1, wherein each of the side edges of the case comprises at least one second cut-out portion for removably receiving at least one button.

4. The case of claim 2, wherein the at least one first cut-out portion is accommodated with a groove made around a camera ring.

5. The case of claim 1, wherein the body is made from at least one of metal, glass, concrete, epoxy, plastics, nylon, polylactic acid, high impact polystyrene, polycarbonate, acrylonitrile butadiene styrene, grapheme, Kevlar, fiberglass, and carbon fiber.

6. the case of claim 1, wherein the composite sheet comprising:
a back glass or Polyethylene terephthalate (PET) acting as the rear face of the case;
a layer of first compound UV glue applied on top of the back glass or PET;
an intermediate polycarbonate (PC) sheet placed on the first compound UV glue, wherein the top side of the PC sheet is used for placement of the magnetic unit through a CNC processing slot, and the bottom side of the PC sheet is placed on the first compound UV glue;
a layer of second compound UV glue applied on top of the intermediate PC sheet; and
a front glass or Polyethylene terephthalate (PET) configured on top of the intermediate PC sheet through the second compound UV glue and acts as the front face of the case.

7. The case of claim 1, wherein the magnetic unit further comprises:
a PC ring with an intermediate, processing slot for receiving one or more magnets;
a first layer of glue for sticking the one or more magnets on top of the PC ring;
the one or more magnets placed on top of the first glue layer; and
a second layer of glue applied on top of the one or more magnets configured on the PC ring for attaching a PET cover for covering the one or more magnets.

8. The case of claim 6, wherein the back glass or Polyethylene terephthalate (PET), and the front glass or Polyethylene terephthalate (PET) comprises a printed layer shaped like a magnetic unit.

9. The case of claim 1, wherein the magnetic unit allows for secure attachment of compatible: accessories.

10. The case of claim 1, wherein the composite sheet is securely attached to the TPU bumper through an adhesive bonding process.

11. The case of claim 1, wherein magnetic unit embedded within the composite sheet facilitates magnetic attachment to compatible accessories, such as magnetic car mounts or stands.

12. The case of claim 1, wherein the composite sheet is formed through a molding process, ensuring precise fit and alignment of the components of the composite sheet.

13. The case of claim 1, wherein the electronic device is a cellular telephone or a smart phone.

14. The case of claim 1, wherein the composite sheet is formed using injection molding or other suitable manufacturing processes.

15. The case of claim 1, wherein the TPU bumper is constructed with a shock-absorbing material to provide enhanced impact resistance.

16. A case for an electronic device having a front face, a rear face, a top edge, a bottom edge, and two opposing side edges, the case comprising:
a body for covering at least a portion of the rear face of the electronic device, the body comprising a composite sheet;
wherein the composite sheet comprising:
a back glass or Polyethylene terephthalate (PET) acting as the rear face of the case;
a layer of first compound UV glue applied on top of the back glass or PET;
an intermediate polycarbonate (PC) sheet placed on the first compound UV glue, wherein the top side of the PC sheet is used for placement of a magnetic unit and the bottom side of the PC sheet is placed on the first compound UV glue;
a layer of second compound UV glue applied on top of the intermediate PC sheet; and
a front glass or Polyethylene terephthalate (PET) configured on top of the intermediate PC sheet through the second compound UV glue and acts as the front face of the case.
a thermoplastic polyurethane (TPU) bumper, wherein the body is integrated with the TPU bumper to form the case.
